(19) United States
(12) Patent Application Publication
(10) Pub. No.: US 2005/0242772 A1
(43) Pub. Date: Nov. 3, 2005

(54) Electronic device

(75) Inventor: Jae-deok Cha, Seoul-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/108,817

(22) Filed: Apr. 19, 2005

(30) Foreign Application Priority Data
Apr. 28, 2004 (KR) 2004-29379

(51) Int. Cl. H02J 7/00

(52) U.S. Cl. 320/115

(57) ABSTRACT

An electronic device operable from one of a battery and a converter and having a plurality of electronic components. A battery supplies electric power having a predetermined voltage level range. An adapter supplies electric power having a voltage level included within the voltage level range of the electric power output from the battery. A converter converts the voltage level of electric power from either the battery or the adapter to have a voltage level adequate to drive the electronic components, thereby decreasing generation of internal heat improving conversion efficiency of the DC/DC converter, and increasing a running time of the battery.

### CROSS-REFERENCE TO RELATED APPLICATIONS

This application claims the benefit of Korean Patent Application No. 2004-29379, filed Apr. 28, 2004, in the Korean Intellectual Property Office, the disclosure of which is incorporated herein by reference.

### BACKGROUND OF THE INVENTION

1. Field of the Invention

The present invention relates to an electronic device with a DC/DC converter allowing either an adapter or a battery to be employed as an electric power source, and more particularly, to an electronic device in which a voltage level range of electric power to be inputted to the DC/DC converter is narrowed and thus design efficiency of the DC/DC converter is improved, thereby decreasing generation of internal heat and increasing a running time of the battery.

2. Description of the Related Art

Generally, portable electronic devices, which employ a battery as an electric power source, are being widely used because they are portable and usable while being carried. Examples of such portable electronic devices include: a portable computer, such as a laptop computer, a personal digital assistant, or the like; a mobile phone; a CD player; a video camcorder; etc. Such an electronic device comprises a connection terminal to which an AC/DC adapter for employing external power source instead of the battery is connected. Where a secondary battery, i.e., a rechargeable battery, is employed as the battery for the electronic device, the AC/DC adapter may be employed in supplying the electric power to recharge the secondary battery in the electronic device.

As the portable electronic device is developed, the battery becomes very important. The reason why the battery is important is because the portable electronic device needs the electric power when the portable electronic device is used while being carried. Accordingly, to meet a user's need of a longtime running portable electronic device, various technologies are being developed to increase a capacity or a running time of the battery. Particularly, a method of increasing the running time of the battery independently of the capacity in the electronic device is being developed, for example, a method of reducing power consumption of the electronic device.

Along with the foregoing trend, an extended battery life (EBL) technology to prolong the battery used in the portable computer has been recently developed. For example, a narrow VDC (NVDC) technology has been proposed by INTEL CORP. as a part of the EBL technology.

According to the NVDC technology, the electric power VDC input to a DC/DC converter has a narrowed range, wherein the DC/DC converter converts the electric power supplied from the adapter or the battery into electric power having voltage levels respectively adequate to drive electronic components of the electronic device.

FIG. 1 is a block diagram of a power supply control system in a conventional electronic device. Referring to FIG. 1, the electronic device using the NVDC technology comprises a main system 140 comprising a plurality of electronic components and an DC/DC converter 142 and implementing an inherent function of the electronic device; an adapter 110 and a battery 120 to supply electric power to the electronic device; a first switch 152 switching the electric power supplied from the adapter 110 to the main system 140; a second switch 154 switching the electric power supplied from the battery 120 to the main system 140; and an adapter sensor 160 sensing whether the adapter 110 is connected

The battery 120 is a secondary battery, i.e., a rechargeable battery, and thus the electronic device comprises a system charger 130 to charge the battery 120 with the electric power supplied from the adapter 110. In the electronic device using the NVDC technology, the system charger 130 is connected to an output terminal of the adapter 110, and outputs the electric power to be employed for recharging the battery 120 or employed as an input power VDC for the DC/DC converter 142 of the main system 140. Hence, the voltage level range of the input power VDC for the DC/DC converter 142 is determined in correspondence to an output voltage level of the battery 120 and an output voltage level of the system charger 130.

For example, where the output voltage level of the adapter 110 is 19V, the voltage level required to charge the battery 120 is 12.6V, the maximum output voltage level of the battery 120 is 11.1V, and the cut-off voltage level of the battery 120 is 9V, the system charger 130 comprises a step-down converter to lower the output voltage level of the electric power from the adapter 110 and changes 19V from the adapter 110 into 12.6V, so that the voltage level of the electric power to be input to the DC/DC converter 142 ranges from 9V to 12.6V. Thus, as compared with a conventional power supply system that directly employs the electric power from the adapter 110 as the input power VDC for the DC/DC converter 142, the input power VDC for the DC/DC converter 142 can have a narrowed voltage level range.

However, according to the NVDC technology, in an adapter mode where the electronic device is supplied with the electric power from the adapter 110, the electric power from the adapter 110 is twice converted by the system charger 130 and the DC/DC converter 142 of the main system 140. Here, the adapter 110 takes the system charger 130 and the DC/DC converter 142 as a load, and thus a loss is generated in the system charger 130 and the DC/DC converter 142, so that there arises a problem that the capacity of the adapter 110 should be increased.

For example, where the step-down converter of the system charger 130 has a conversion efficiency of 90% and the DC/DC converter 142 has a conversion efficiency of 85%, the whole conversion efficiency is 76.5% at the adapter mode. In this case, the conversion efficiency is decreased by 13.5% as compared with the conventional system that directly employs the electric power from the adapter 110 as the input power VDC for the DC/DC converter 142.

### SUMMARY OF THE INVENTION

Accordingly, an aspect of the present invention is to provide an electronic device, in which a voltage level range of electric power to be input to a DC/DC converter is narrowed without a power loss, improving a design efficiency of the DC/DC converter, thereby decreasing generation of internal heat and prolonging a running time of the battery.

The foregoing and/or other aspects of the present invention are also achieved by providing an electronic device including a plurality of electronic components; a battery supplying electric power having a predetermined voltage level range; an adapter supplying electric power having a voltage level included within a voltage level range of the electric power output from the battery; and a converter converting the voltage level of the electric power from either the battery or the adapter to a voltage level adequate to drive the plurality of electronic components.

According to an aspect of the present invention, the electronic device further comprises a battery charger to charge the battery with the electric power supplied from the adapter, and a power selector to select the electric power to be supplied from either the battery or the adapter to the converter.

According to an aspect of the present invention, the battery charger comprises a voltage converter to convert the electric power outputted from the adapter into electric power having a voltage level required for charging the battery.

According to an aspect of the present invention, the voltage converter comprises a boost converter.

According to an aspect of the present invention, the adapter supplies the electric power having a voltage level approximate to a voltage level of electric power required for charging the battery.

According to an aspect of the present invention, the electronic device further comprises an adapter sensor to sense whether the adapter supplies the electric power, wherein the power selector selects the electric power supplied from the adapter to be employed as input power for the converter where the adapter sensor senses that the adapter supplies the electric power.

According to an aspect of the present invention, the electronic device further comprises an adapter sensor to sense whether the adapter supplies the electric power and a power selector to select the electric power to be supplied from either the battery or the adapter to the converter, wherein the power selector selects the electric power supplied from the adapter to be employed as input power for the converter when the adapter sensor senses that the adapter supplies the electric power.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

The above and/or other aspects and advantages of the present invention will become apparent and more readily appreciated from the following description of the embodiments, taken in conjunction with the accompany drawings of which:

FIG. 1 is a block diagram of a power supply system in a conventional electronic device;

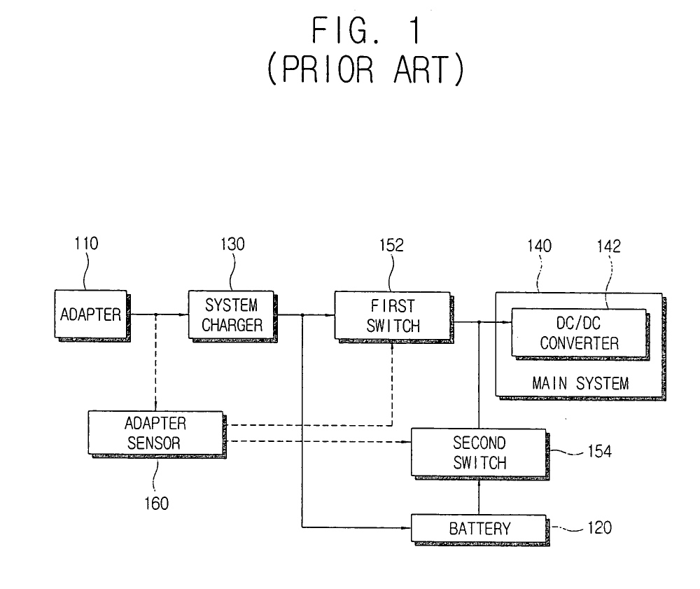

FIG. 2 a block diagram of a power supply system in an electronic device according to an embodiment of the present invention; and

FIG. 3 is a circuit diagram of a boost converter in a battery charger of an electronic device according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

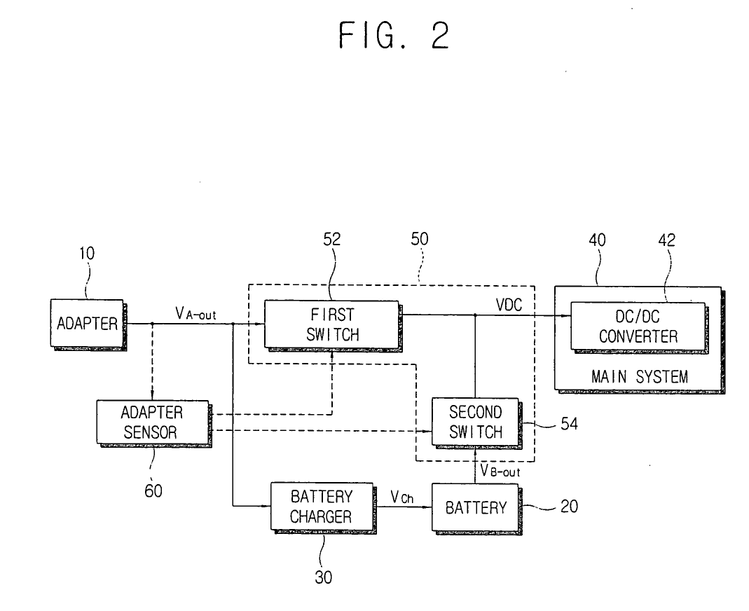

Referring now to FIG. 2, an electronic device according to an embodiment of the present invention comprises an adapter 10, a battery 20 and a main system 40.

The main system 40 comprises a plurality of electronic components for performing inherent functions when electric power is supplied thereto. For example, where the electronic deice is a portable computer, the plurality of electronic components in the main system 40 comprises a central processing unit (CPU), a memory such as a random access memory (RAM), a chipset, a main board, a graphic card, etc.

Further, the main system 40 comprises a converter, e.g., a DC/DC converter 42 to convert electric power VDC (V_{A-out} or V_{B-out}) from the adapter 10 or the battery 20, respectively, into electric power having voltage levels adequate to drive the respective electronic components. Here, the DC/DC converter 42 may comprise a plurality of switching voltage regulators to regulate various voltage levels according to specifications of the electronic device. For example, where the electronic device is the portable computer, the switching voltage regulators of the DC/DC converter 42 output various voltage levels, e.g., ±5V, ±3.3V, and ±2.5V, needed to drive the electronic components. Thus, the electric power of various voltage levels output from each switching voltage regulator is supplied to the electronic components as necessary to drive the electric components or transmit a signal to the electric components.

The battery 20 comprises a secondary battery, i.e., a rechargeable battery rechargeable by a battery charger 30. For example, the battery 20 may comprise a rechargeable lithium-ion battery or other rechargeable secondary batteries. Here, the battery 20 comprises at least one battery cell having predetermined specifications regarding charging and output voltages. According to an embodiment of the present invention, the battery 20 may comprise three battery cells connected in series. Hereinbelow, the embodiment will be described supposing that a voltage level of the electric power needed to charge each battery cell is 4.2V, a voltage level of the electric power output from each battery cell is 3.7V, and a cut-off voltage level of the battery 20 is 3V. Therefore, the voltage level of an electric power VCh needed to charge the battery 20 is 12.6V, and the voltage level VB-out of the electric power output from the battery 20 ranges from 9V through 11.1V.

The adapter 10 comprises an AC/DC adapter 10 for converting commercial AC power into DC power. Alternatively, the adapter 10 may comprise a DC/DC adapter for accessing power from a cigarette lighter jack, such as used in automobiles, which employs the DC power as an input power. Here, the voltage level of the electric power VA-out output from the adapter 10 is included within the voltage level range of the electric power VB-out outputted from the battery 20. For example, as described above, when the battery 20 outputs the electric power VB-out having a voltage level of 9V through 11.1V, the adapter 10 outputs the electric power VA-out having a voltage level ranging within 9V through 11.1V of the battery 20.

The voltage level of the electric power VA-out output from the adapter 10 may be approximate to the voltage level of the electric power VCh required to charge the battery 20. For example, where the voltage level of the electric power VCh required to charge the battery 20 is 12.6V, the adapter 10 preferably outputs a voltage level, e.g., of 10V, approximate to 12.6V. In this case, the voltage level of the electric power VA-out outputted from the adapter 10 is also included within the voltage level range of the electric power VB-out outputted from the battery 20. Therefore, a power loss due to the voltage conversion in the battery charger 30 is reduced.

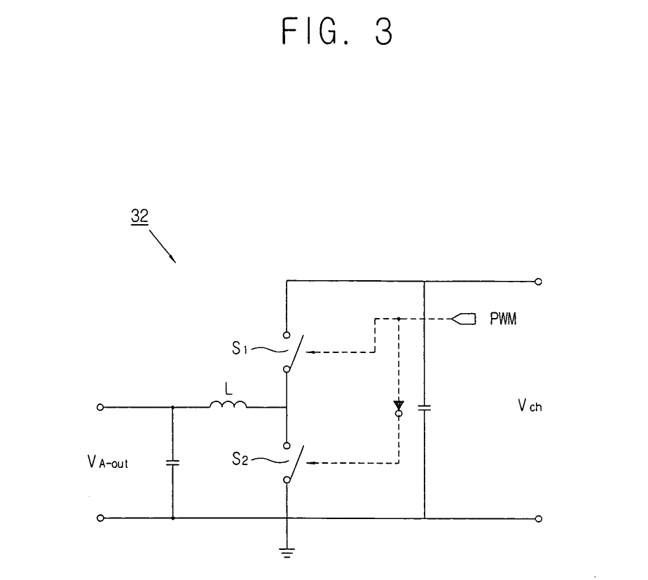

The battery charger 30 charges the battery 20 with the electric power VA-out supplied from the adapter 10. As shown in FIG. 3, the battery charger 30 comprises a voltage converter such as a boost converter 32 to change the electric power VA-out output from the adapter 10 into the electric power VCh having a voltage level required for charging the battery 20.

Referring to FIG. 3, the boost converter 32 comprises a first switching device S1 and a second switching device S2, which are turned on/off in response to a control signal, e.g., a pulse width modulation (PWM) signal of a controller (not shown) and an inductor L. Further, under conditions that the boost converter 32 is being supplied with the electric power from the battery charger 30, when the first switching device S1 is turned off and the second switching device S2 is turned on in response to the PWM signal, the electric power of the battery charger 30 is stored in the inductor L. On the other hand, when the first switching device S1 is turned on and the second switching device S2 is turned off in response to the control signal, the battery 20 is charged with the electric power stored in the inductor L and the electric power VA-out supplied from the adapter 10. Here, the boost converter 32 of the battery charger 30 preferably comprises a synchronous boost converter, but may comprise various converters such as a step-up converter as long as the converter used increases the voltage level of the electric power supplied from the battery charger 30 to the voltage level required for charging the battery 20.

Thus, the voltage level of the electric power VA-out supplied from the adapter 10 is boosted to the voltage level required for charging the battery 20, and is employed as the electric power VCh for charging the battery 20. For example, where the adapter 10 according outputs a voltage level of 10V, the boost converter 32 boosts the 10V to 12.6V required for charging the battery 20, so that the battery 20 is charged with the electric power VCh of 12.6V.

The electronic device according to an embodiment of the present invention further comprises a power selector 50 allowing the electric power supplied from either the adapter 10 or the battery 20 to be employed as the input power VDC for the DC/DC converter 42; and an adapter sensor 60 sensing whether the adapter 10 outputs the electric power VA-out. The power selector 50 selects the electric power VA-out supplied from the adapter 10 to be employed as the input power VDC for the DC/DC converter 42 when the adapter sensor 60 senses that the adapter 10 outputs the electric power VA-out. The power selector 50 comprises a first selector switch 52 and a second selector switch 54, which are turned on/off in response to a sensing result of the adapter sensor 60. The first selector switch 52 is provided at an output terminal of the adapter 10 and switches the electric power supplied from the adapter 10 to the DC/DC converter 42. The second selector switch 54 is provided at an output terminal of the battery 20 and switches the electric power supplied from the battery 20 to the DC/DC converter 42. Alternatively, the first and second selector switches 52 and 54 of the power selector 50 may comprise a switching device such as a field effect transistor (FET), and forward-biased diodes (not shown) respectively connected to the output terminals of the adapter 10 and the battery 20.

An operation of the power supply system of the electronic device according to the embodiment described with respect to FIGS. 2 and 3 will be described.

When the adapter sensor 60 senses that the electric power VA-out is not supplied from the adapter, the power selector 50 allows the electric power VB-out supplied from the battery 20 to be employed as the input power VDC for the DC/DC converter 42 (hereinafter, referred to as “battery mode”). In the battery mode, the voltage level of the electric power V_{B-out} supplied from the battery 20 ranges within 9V through 11.1V, otherwise, where the battery output voltage V_{B-out} is 9V or less, the electric power supplied from the battery 20 is cut off. Thus, in the battery mode, the input power VDC for the DC/DC converter 42 of the main system 40 ranges from 9V through 11.1V as the electric power V_{B-out} supplied from the battery 20.

Where the adapter sensor 60 senses that the electric power V_{A-out} is supplied from the adapter, the power selector 50 allows the electric power V_{A-out} supplied from the adapter 10 to be employed as the input power VDC for the DC/DC converter 42 (hereinafter, referred to as “adapter mode”). Thus, in the adapter mode, the input power VDC for the DC/DC converter 42 of the main system 40 has a voltage level of 10V as the electric power V_{A-out} supplied from the adapter 10, so that the voltage level range of the input power VDC is included within 9V through 11.1V, that is, within the voltage level range of the electric power V_{B-out} suppliable from the battery 20.

Thus, in the electronic device according to an embodiment of the present invention, the voltage level range of the input power VDC for the DC/DC converter 42 ranges from 9V to 11.1V regardless of whether the electronic device is being operated in the adapter mode or the battery mode. Hence, the voltage level range of the input power VDC for the DC/DC converter 42 is more narrowed than the conventional power supply system including the NVDC technology, so that a number of devices, used in the DC/DC converter 42, such as a number of capacitors or a capacity thereof may be decreased, thereby reducing the size of a substrate including the DC/DC converter.

Further, in the DC/DC converter 42, a switching device, such as an FET, having a low breakdown voltage, may be employed in the DC/DC converter 42. Further, a switching loss or a current loss is decreased, so that the efficiency of the DC/DC converter 42 is improved. Also, in the adapter mode, the electric power VA-out supplied from the adapter 10 is once converted by only the DC/DC converter 42, so that a power loss due to multiple voltage conversions is reduced as compared with the conventional system using the NVDC technology, thereby realizing the EBL.

In the foregoing embodiment, a battery comprising three battery cells in series is employed as the battery 20. However, a battery comprising one or another plurality of battery cells may be used and the voltage output level of the adaptor 10 may be scaled according to a number of cells in the battery. That is, where the battery is formed of lithium-ion cells, the output voltage level of the adaptor would range from about 3 volts multiplied by the number of cells to about 3.7 volts multiplied by the number of cells. Further, the adapter 10 and the boost converter 32 of the battery charger 30 may vary in specification and capacity according to specifications related to charging and discharging of each battery cell.

As described above, the present invention provides an electronic device, in which a voltage level range of input power VDC for a DC/DC converter is narrowed without a power loss and thus design efficiency of the DC/DC converter is improved, thereby decreasing generation of internal heat of the electronic device and prolonging a running time of the battery.

Although a few embodiments of the present invention have been shown and described, it would be appreciated by those skilled in the art that changes may be made in these embodiments without departing from the principles and spirit of the invention, the scope of which is defined in the claims and their equivalents.

1. An electronic device with a plurality of electronic components, comprising:
a battery supplying electric power having a predetermined voltage level range;
an adapter supplying electric power having a voltage level included within the voltage level range of the electric power output from the battery; and
a converter converting the voltage level of the electric power from either the battery or the adapter to a voltage level adequate to drive the plurality of electronic components.

2. The electronic device according to claim 1, further comprising a battery charger to charge the battery with the electric power supplied from the adapter.

3. The electronic device according to claim 2, further comprising a power selector to select the electric power to be supplied from either the battery or the adapter to the converter.

4. The electronic device according to claim 2, wherein the battery charger comprises a second voltage converter to convert the electric power output from the adapter into electric power having a voltage level required for charging the battery.

5. The electronic device according to claim 4, wherein the second voltage converter comprises a boost converter.

6. The electronic device according to claim 1, wherein the adapter supplies the electric power having a voltage level approximate to a voltage level of electric power required for charging the battery.

7. The electronic device according to claim 3, further comprising an adapter sensor to sense whether the adapter supplies the electric power, wherein:
where the adaptor sensor senses that the adaptor supplies the electric power, the power selector selects the electric power supplied from the adapter to be employed as input power for the converter.

8. An electronic device having a plurality of electronic components, the electronic device comprising:
a battery which supplies electric power having a predetermined voltage level range;
an adapter which supplies electric power having a voltage level included within the predetermined voltage level range;
a first converter which converts the voltage level of the electric power supplied from the battery or the adapter to a voltage level adequate to drive the plurality of electronic components; and
a second converter which converts the voltage level of the electric power supplied by the adapter to a voltage level required to charge the battery.

9. The electronic device according to claim 8, further comprising:
a power selector which switches the electric power from the adapter to supply the electric power to the first converter where the electric power is available from the adapter or switches the electric power from the battery to supply the electric power to the first converter where the electric power from the adapter is not available.

10. The electronic device according to claim 8, further comprising:
a sensor which senses whether the electric power is available from the adapter.

11. The electronic device according to claim 8, wherein the voltage level supplied by the adapter is within a range having a lower value of about a cutoff voltage of the battery and an upper value of about a fully charged voltage of the battery.

12. The electronic device according to claim 11, wherein the battery comprises three lithium-ion cells and the voltage level supplied by the adapter is in a range of about 9 volts to about 11.1 volts.

13. The electronic device according to claim 8, wherein the voltage level supplied by the adapter is within a range having a lower value of about a cutoff voltage of a cell of the battery multiplied by a number of cells in the battery and an upper value of about a fully charged output voltage of the cell multiplied by the number of cells in the battery.

14. The electronic device according to claim 13, wherein the battery comprises one lithium ion cell or a plurality of lithium ion cells and the voltage level supplied by the adapter is in a range of about 3 volts per cell to about 3.7 volts per cell.

15. An electronic device with a plurality of electronic components, comprising:
a battery outputting a electric power having a predetermined voltage level range;
an adapter outputting a electric power having a predetermined voltage level; and
a converter converting a voltage level of the electric power input from either the battery or the adapter to a voltage level to drive the plurality of electric component, wherein the voltage level of the electric power input to the converter is equivalent to the voltage level range of the electric power output from the battery.

16. The electronic device according to claim 15, wherein the voltage level of the electric power output from the adapter is included within the voltage level range of the electric power output from the battery.

17. The electronic device according to claim 16, further comprising a battery charger to charge the battery with the electric power output from the adapter.

18. The electronic device according to claim 17, wherein the battery charger comprises a second voltage converter to convert the electric power output from the adapter into electric power having a voltage level required for charging the battery.

19. The electronic device according to claim 18, wherein the second voltage converter comprises a boost converter.

20. A method of controlling an electronic device having a plurality of electric component, comprising:
outputting a electric power having a predetermined voltage level range from a battery;
outputting a electric power having a predetermined voltage level;
inputting the electric power from either the battery or the adapter to a converter; and converting the voltage level of the electric power input to the converter to a voltage level to drive the plurality of electric component by the converter, wherein the voltage level of the electric power input to the converter is equivalent to the voltage level range of the electric power output from the battery.

21. The method according to claim 20, wherein the voltage level of the electric power output from the adapter is included within the voltage level range of the electric power output from the battery.

22. The electronic device according to claim 20, further comprising:
busting the voltage level of the electric power output from the adapter; and
charging the battery with the electric power converted by the converter.
